(19) United States
(12) Patent Application Publication
(10) Pub. No.: US 2008/0242916 A1
(43) Pub. Date: Oct. 2, 2008

(54) Eecp Device and an Image System Comprising the Same

(76) Inventor: Yuval Avni, Giv'ataim (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/090,423

(22) PCT Filed: Oct. 16, 2006
(86) PCT No.: PCT/IL06/01189

§ 371 Date: Apr. 16, 2008

(30) Foreign Application Priority Data
Oct. 16, 2005 (IL) 171448

(51) Int. Cl. A61M 1/10

(52) U.S. Cl. 600/17

(57) ABSTRACT

The present invention discloses a non-invasive rigid-support enhanced external counterpulsation device (RS-EECP) providing a precise onset of a blood flow characterized by a sharp-wave front, useful for out-patient treatment of arterial insufficiency states, especially angina; said RS-EECP comprising a timing means and a plurality of pressing cuffs; said timing means is adapted to onset the collapsing and expanding maneuvers of the cuffs in a sequence of occasions defined along the diastolic/systolic cycle; said cuffs are fastened around at least a portion of the circumference of at least one organ comprising a vascular bed to counterpulsate against an either fixed or maneuverable support; wherein said support is a rigid member; so as a quick expansion of said vessel bed, following a forceful and effective collapsing of the same is obtained.

### FIELD OF THE INVENTION

The present invention relates to medical apparatus for increasing vascular blood flow and tissue perfusion to various organs of a patient and to methods of using such apparatus in various imaging modalities in order to improve the anatomical and physiological visualization.

### BACKGROUND OF THE INVENTION

Enhanced external counterpulsation (EECP) is a non-invasive treatment that uses timed, sequential inflation of pressure cuffs on the calves, thighs and buttocks to augment diastolic pressure, decrease left ventricular afterload, and increase venous return. Augmenting diastolic pressure displaces a volume of blood backwards into the coronary arteries during diastole when the heart is in a state of relaxation and the resistance in the coronary arteries is at a minimum. The resulting increase in coronary artery perfusion pressure may enhance coronary collateral development, increase cardiac perfusion pressure or increase flow through existing collaterals. In addition, when the left ventricle contracts, it faces a reduced aortic pressure to work against since the cuffs deflate rapidly right before the systole. EECP has been primarily investigated as a treatment for chronic stable angina.

Practically, a regular treatment is exercised in a manner that patients lie down on a padded table in a treatment room. Three electrodes are applied to the skin of the chest and connected to a monitoring system; usually a probe of a blood pressure sensor and an electrocardiograph (ECG), which displays the heart's rhythm during treatment, is also monitored.

FIG. 1 presents a schematic illustration of EECP counterpulsation mechanism as defined in the prior art, and a generalized four pulsation steps (A-D). FIG. 1 also presents a diagram of the same presenting four schematic steps of the commercially available EECP equipment:

Inflation initiates retrograde pulse wave (step 1); inflation of lower thigh cuffs 50 ms later (step 2); inflation of upper thigh cuffs 50 ms later (step 3) and lastly, deflation facilitates cardiac unloading (step 4). EECP is generally utilized for treating angina pectoris and other arterial insufficiency states. Angina is a chronic chest pain or discomfort appearing when the heart muscle doesn't get enough blood and oxygen supply, are insufficient for the work it's doing. External counterpulsation techniques, such as the EECP, were shown in the art to improve the balance between the amount of oxygen the heart needs and the amount it gets. Both these changes reduce the pain of angina, increase level of daily activities & effort and decrease the need for medication.

It is well established that timing of the inflation/deflation steps of the EECP pulsation is a critical parameter in the procedure. Various approaches were implemented and experimented with improved timing means. U.S. Pat. No. 6,736,786 presents a counterpulsation device that operates without the use of compressed air or pressurized gas, which includes at least one inflatable cuff that is adapted to be placed upon a selected portion of the patient's body. Here, a conduit connects the inflatable cuff to an air transfer device so that non-compressed air can be transferred from the air transfer device to the cuff through the conduit to inflate the cuff. The conduit also connects the cuff to the air transfer device so that air can flow through the conduit to deflate the cuff. Another conduit is coupled to the first so that the air in the system can be selectively vented into the atmosphere. A series of valves are placed on the conduit to selectively control whether air is supplied to or withdrawn from the inflatable cuff. The air moving device preferably is a cylinder having a piston that moves through the cylinder to move the air from within the cylinder through the conduit and into or out of the cuff as desired. The piston moves through the cylinder through the use of a linear servo actuator that is controlled by an appropriately programmed electronic controller so that the inflation of the cuff is timed with portions of the patient's EKG signal and peripheral plethysmographic wave.

Nevertheless, most of the cuffs are elastic sleeve-like members, adapted to shrink, i.e., decrease its diameter at a given time, to expand and vice versa. Hence, U.S. Pat. No. 4,753,226 discloses an EECP massage apparatus comprising a plurality of air-filled balloons. US patent application 2005/043657 provides an exterior counterpulsation system that includes a garment for being worn on the exterior of a patient's body. This garment is made of electroactive polymer actuators connected thereto. US patent application 2002/107461 teaches an EECP device having timing of inflation and deflation and reduced temperature of the pressurized gas, such that the gas flow temperature of the inflatable devices is near to room temperature, as well as faster and more responsive inflation/deflation equipment. The external counter-pulsation apparatus includes a plurality of inflatable devices received about the lower extremities of the patient, a source of compressed fluid in communication with said plurality of inflatable devices, and a fluid distribution assembly interconnecting said source of compressed fluid and said inflatable devices. The fluid distribution assembly includes a selectively operable inflation/deflation valve interconnected between each of said inflatable devices and said source of compressed fluid. The fluid distribution assembly separately operates each inflation/deflation valve to sequentially inflate and deflate each inflatable device.

US patent application 2002/169399 defines a cardiac assist device includes a sealed tubular housing for externally applying positive and negative relative pressure to a limb in counterpulsation with heart function. The applicator is assembled, in situ, to provide customized fit. It includes a fabric or sponge-like inner layer cut to size and situated around the limb. Initially deformable material is sized, sealed around the inner fabric layer and then secured by straps or the like to form a relatively rigid, non-expandable tubular shell. The shell may include an interior wall composed of a sheet of hard plastic or articulated sections of hard plastic or metal. The interior wall has a plurality of openings to the sealed shell interior. The exterior shell wall is positioned around the interior wall. The shell walls are spaced apart by radially and/or longitudinally extending spacer elements defining a multi-section air flow chamber between the walls. The interior shell wall and spacer elements may be integral. The spacer elements include passages so that air pumped into and out of the shell chamber is uniformly distributed and moves freely to and from the shell interior.

It is known from the art that medical imaging modalities depict the anatomical and physiological status of the human organs. IV contrast materials are used to visualize blood flow to organs such as the heart, liver, brain etc, and to demonstrate the normal and abnormal blood supply to these organs. Current vascular and cardiac imaging is associated with high radiation exposure, high concentration of contrast material associated side effects and limited specificity and sensitivity. Imaging tests are extensively used in all medical fields, with a constant increase in utilization for screening and invasive procedure replacement. Cardiac CT for instance, strives to become a general public screening test for early diagnosis of cardiac ischemia. The sensitivity and specificity of the various modalities in demonstrating vascular and cardiac pathologies is limited.

While the EECP devices are currently provided useful solely for treating angina pectoris and other arterial insufficiency states, their main mechanical disadvantage is timing of the cuffs such that an exact and effective operation of the vein or artery device inflation/deflation is not provided at an exact and predetermined timing.

### SUMMARY OF THE INVENTION

It is one object of the present invention to disclose a non-invasive rigid-support enhanced external counterpulsation device (RS-EECP) providing a precise onset of a blood flow characterized by a sharp-wave front. This novel RS-EECP is useful for out-patient treatment of arterial insufficiency states, especially angina.

It is comprised of ingredients selected in a non-limiting manner from a timing means and a plurality of pressing cuffs. The timing means is adapted to onset the collapsing and expanding maneuvers of the cuffs in a sequence of occasions defined along the diastolic/systolic cycle, The cuffs are fastened around at least a portion of the circumference of at least one organ comprising a vascular bed to counterpulsate against an either fixed or maneuverable support. The improvement is that the support is at least partially rigid member; so as a quick expansion of said vessel bed, following a forceful and effective collapsing of the same is obtained.

It is one aspect of the present invention wherein the RS-EECP comprising two or more pressing cuffs, being arranged adjacently along the patient's organ in a series such that one cuff or cuffs are located at a retrograde position in respect to others.

It is another aspect of the present invention wherein the cuff or cuffs are located at the retrograde position are scheduled to collapse prior to others, such as a unidirectional blood flow is provided.

It is another aspect of the present invention to disclose an array of RS-EECPs, each of which is defined in a non-limiting manner above, further comprising two or more RS-EECPs, being arranged along the patient's body in series and/or in parallel, such that at least one RS-EECP is located at a retrograde position in respect to others.

It is another aspect of the present invention wherein one or more RS-EECPs is located at the retrograde position, and scheduled to collapse prior to others, such as a peristaltic unidirectional blood flow along the treated patient's body portion is provided.

It is another aspect of the present invention wherein the aforementioned RS-EECP is in communication with at least one imaging means (namely ‘IRS-EECP’). The imaging means are adapted to display said blood flow or the flow of markers or medicaments solubilized therein, or tissue perfusion.

It is another aspect of the present invention wherein the imaging modality is selected from cardiac CT, CT-angio, cardiac and vascular MRI, ultrasound Doppler for the carotids and renal vessels, isotope based scans, as PET scans or any combination thereof.

It is another aspect of the present invention wherein the markers, contrasting agents and/or image contrasting means are selected from all substances, compositions or agents used for enhancing or depicting vascular flow or as a measure of tissue perfusion or perfusion pressure, in conjunction with the above mentioned imaging modalities, for example iodine based materials, isotopes, ferromagnetic substances, micro bubbles etc.

It is another aspect of the present invention wherein the medicaments such as nitroglycerin and dopamine.

It is another aspect of the present invention to disclose a RS-EECP (100) comprising in a non-limiting manner a plurality of rotating-cuffs (1) and a mechanism for rotating the same (2). The rotating-cuffs (1) comprising inter alia at least one set of rotating cuffs being either at least partially flexible or rigid; and at least one rigid-support. The said maneuverable cuff has an open configuration (collapsed state) and a closed configuration (released state). At said collapsed state, the cuffs are fastened around at least a portion of the circumference of at least one organ comprising a vascular bed to counterpulsate against an either fixed or maneuverable support.

It is another aspect of the present invention to disclose a RS-EECP (100) that is further having at least one rotating shaft (3), being either concentric or eccentric member. Shaft (3) is connected to a motor, rotating the same; and hence, either directly or indirectly, it forcefully compresses the maneuverable cuffs.

It is another aspect of the present invention to disclose a RS-EECP (200) comprising inter alia a plurality of pressing-cuffs (1) and a mechanism for pressing the same (2). The RS-EECP (200) may further comprise one or more maneuverable cuffs (31) being connected to a shaft having a linear (e.g., approximately perpendicular) motion (32), such as at a given time, said pressing cuffs are fastened towards a rigid support (33).

It is another aspect of the present invention to disclose an RS-EECP (100), further including an external fixation means adapted to immobilize legs, thighs and upper torso during activation of the RS-EECP. The aforesaid means are selected in a non-limiting manner from strips, straps, pillory, or any other immobilizing means.

It is another aspect of the present invention to disclose an RS-EECP (100) further comprising a portable CPR device, especially adapted to be utilized in trauma and pre-hospital medical treatment, e.g., ambulances etc, and in hospitals. Moreover, the aforesaid portable CPR is utilizable in domestic, commercial, sport centers, clinics, etc.

It is another aspect of the present invention to disclose a portable CPR utilizable independently, in conjunction and/or in communication with a defibrillator, providing a synergic resuscitating system; said synergic resuscitating system further comprising at least one controlling means.

It is a second object of the present invention to present a non-invasive method for out-patient treating of arterial insufficiency states, especially angina by providing a precise onset of a blood flow characterized by a sharp-wave front.

It is another aspect of the present invention wherein the aforesaid method comprising steps selected in a non-limiting manners from (a) obtaining a timing means and a plurality of pressing cuffs; (b) fastening cuffs around at least a portion of the circumference of at least one organ comprising a vascular bed to counterpulsate against an either fixed or maneuverable support; wherein said support is a rigid member; and (c) initiating the collapsing and expanding maneuvers of the cuffs in a sequence of occasions defined along the diastolic/systolic cycle; such as a quick expansion of said vessel bed, following a forceful and effective collapsing of the same is obtained.

It is another aspect of the present invention wherein the method comprising a step of obtaining two or more pressing cuffs, setting the same adjacently along the patient's organ in a series such that one cuff or cuffs are located at a retrograde position in respect to others.

It is another aspect of the present invention wherein the aforesaid method comprising locating cuff or cuffs at a retrograde position and then collapsing the same prior to others, such as a unidirectional blood flow is provided.

It is another aspect of the present invention wherein the method comprising a step of obtaining two or more RS-EECPs and arranging the same along the patient's body in series and/or in parallel, such that at least one RS-EECP is located at a retrograde position in respect to others.

It is another aspect of the present invention wherein the method comprising a step of locating one or more RS-EECPs at the retrograde position and initiating the same to collapse prior to others, such as a peristaltic unidirectional blood flow along the treated patient's body portion is provided.

It is another aspect of the present invention wherein the method further comprises an external fixation means adapted to immobilize legs, thighs and upper torso during the activation of the RS-EECP by plural means selected in a non-limiting manner from strips, straps, pillory, or any other immobilizing means.

It is another aspect of the present invention wherein the method comprising a step or steps of communicating the RS-EECP system with at least one imaging means (i.e., IRS-EECP). The imaging means are preferably adapted for displaying said blood flow or the flow of markers or medicaments solubilized therein.

It is another aspect of the present invention wherein the imaging is selected from providing cardiac CT, CT-angio, cardiac and vascular MRI, ultrasound Doppler for the carotids and renal vessels, isotope based scans, as PET scans or any combination thereof.

It is another aspect of the present invention wherein the method comprising utilizing medicaments being selected in anon-limiting manner from dopamine, nitroglycerine or milrinon (a PDE-III-inhibitor).

It is another aspect of the present invention wherein the method comprises utilizing a portable CPR device independently, in conjunction and/or in communication with a defibrillator, providing a synergic resuscitating system. The synergic resuscitating system further comprising at least one controlling means.

### BRIEF DESCRIPTION OF THE FIGURES

In order to understand the invention and to see how it may be implemented in practice, few preferred embodiments will now be described, by way of non-limiting example only, with reference to the accompanying drawing, in which

FIG. 1 presents a commercially available EECP operating scheme of a commercially available device;

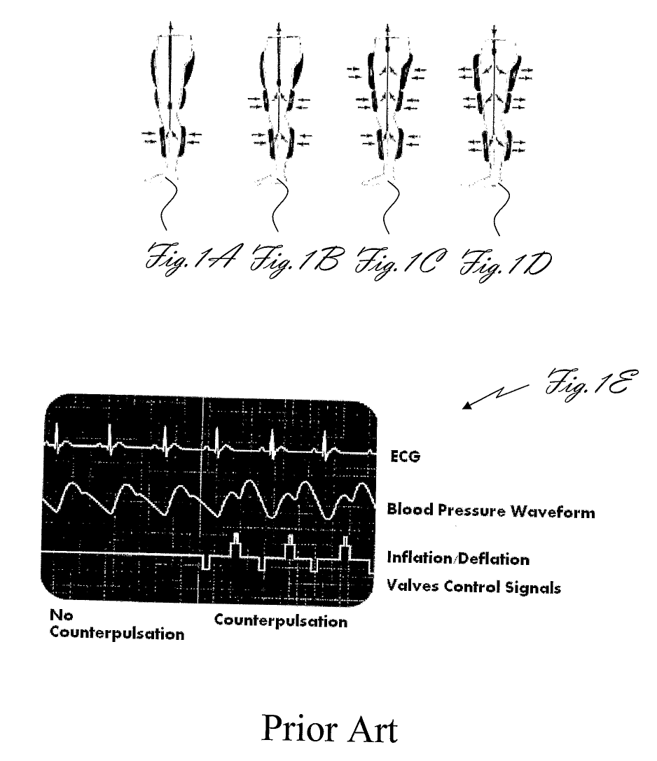

FIG. 2 presents an RS-EECP according to one embodiment of the present invention;

FIG. 3 presents an RS-EECP according to yet another embodiment of the present invention;

FIG. 4 presents a commercially available EECP with two flexible cuffs; and,

FIG. 5 presents an RS-EECP according to yet another embodiment of the present invention, comprising one flexible cuff and one rigid support.

### DETAILED DESCRIPTION OF THE EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a non-invasive rigid-support enhanced external counterpulsation device (RS-EECP) and methods of providing a precise onset of a blood flow characterized by a sharp-wave front, useful for out-patient treatment of arterial insufficiency states, especially angina.

The term ‘counterpulsation’ refers hereinafter to a technique that synchronizes the external pumping of blood with the heart's cycle to assist the circulation and decreasing the work of the heart. The term is usually used wherein counterpulsation pumps when the heart is resting to increase blood and oxygen flow to the heart; and wherein counterpulsation has a fast decrease in pressure when the heart is working to decrease the heart's workload and lessen oxygen demand.

The term ‘enhanced external counterpulsation’ (EECP) refers hereinafter to a non-invasive out-patient treatment for heart disease and, in particular, for angina. EECP is designed to relieve angina by improving perfusion in areas of the heart deprived of an adequate blood supply.

The term ‘perfusion’ a physiological term that refers to the process of nutritive delivery of arterial blood to a capillary bed in the biological tissue. The term ‘perfusion pressure’ refers to the arterial pressure minus venous pressure.

The term ‘diastole’ refers hereinafter to the time period when the heart is in a state of relaxation and dilatation (expansion). The diastolic pressure is specifically the minimum arterial pressure during relaxation and dilatation of the ventricles of the heart. Diastole is the time when the ventricles fill with blood.

The term ‘vascular bed’ refers hereinafter to the vascular system, or a part thereof: for example, the pulmonary vascular bed describes the blood vessels of the lungs.

The term ‘cardiac output’ refers hereinafter to the amount of blood that is pumped by the heart per unit time, measured in liters per minute (l/min), usually about 4.7 liters/minute. The amount of blood that is put out by the left ventricle of the heart in one contraction is called the stroke volume. The stroke volume multiplied by the heart rate is the cardiac output.

The term ‘arterial insufficiency states’ refers hereinafter to heart pathologies and vascular bed pathologies, conditions and pains, malfunctions and symptoms, such as angina and especially angina pectoris (typical Canadian Cardiovascular Society Classes I, II and III angina), deep vein or artery thrombosis, edema, lymph edema, left ventricular dysfunction, incidence and complications of diabetic and other chronic obstructive coronary disease and arterial insufficiency states.

The term ‘cardiopulmonary resuscitation’ (CPR) refers hereinafter to an emergency first aid protocol for an unconscious person on whom both breathing and pulse cannot be detected. More specifically, the term CPR is used hereinafter to define an EECP device especially adapted to portable use.

The imaged RS-EECP (IRS-EECP) according to the present invention increases blood flow to the heart, kidneys, liver, etc., increases organ perfusion and differentially accentuates flow and perfusion mismatches. Hence, the novel system lowers radiation exposure; reduces dose of contrast material; diminishes risk for side effects; increases specificity and sensitivity; increases patient compliance and increased span of imaging procedures.

Moreover, a main problem characterizing the current imaging techniques is the exposure to high dose ionizing radiation and its long term effects, and contrast material side effects and allergies, leading to serious complications and even death.

The IRS-EECP according to the present invention reproduces non-invasively the action of an intra aortic balloon counter pulsation. It increases the blood flow and perfusion in various organs such as the heart, kidneys and liver. The system also differentially accentuates the flow and perfusion mismatches, between healthy (normally oxygenated) and non-healthy (relatively ischemic) tissues, improving the sensitivity and specificity of medical diagnostic imaging tests.

The aforesaid IRS-EECP is utilized to significantly improve the anatomical and physiological visualization, in various imaging modalities. This results in decreased total doze of radiation, and reduction in the total dose of contrast materials including isotopes, resulting in a lower rate of side effects. It also increases patient compliance, and reduces costs.

It is in the scope of the present invention wherein the IRS-EECP comprising imaging means selected from cardiac CT, CT-angio, cardiac and vascular MRI, ultrasound Doppler for the carotids and renal vessels, isotope based scans, as PET scans or any combination thereof.

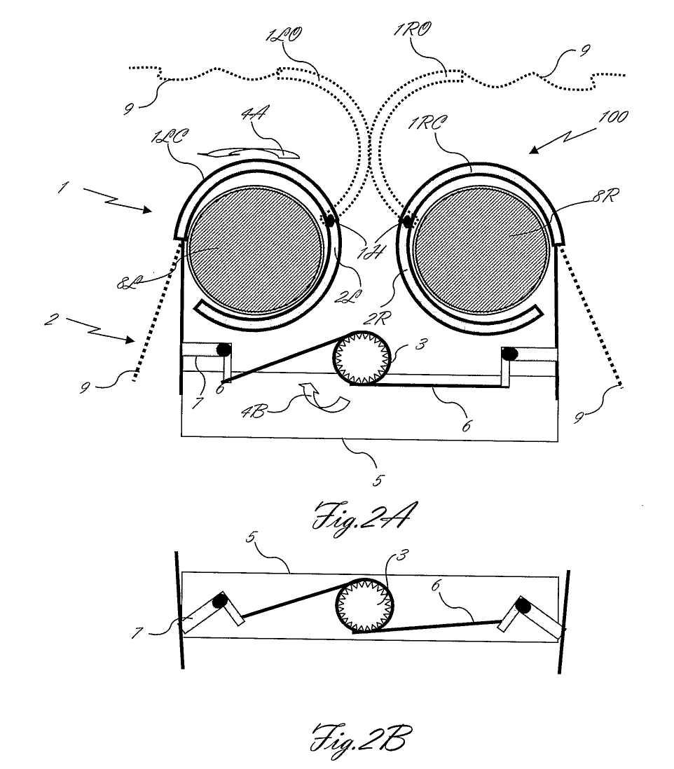

Reference is made now to FIG. 2, presenting a schematic cross section of a noninvasive rigid-support EECP device (RS-EECP, 100) adapted for sequential inflation of a plurality of pressure cuffs against a non-flexible (rigid)-support on the calves, thighs and buttocks to augment diastolic pressure, decrease left ventricular afterload, and increase venous return. This RS-EECP (100) is a rotating-flaps model according to one embodiment of the present invention comprising inter alia two operational modules: a plurality of rotating-flaps provided as the pressure cuffs (1) and a flaps rotating mechanism (2). FIG. 2 is schematically illustrating the RS-EECP device in its two extreme phases: when filly released, i.e., schemes A, upper view; and when fully compressed, i.e., scheme B, lower and partial view presenting only rotating mechanism (2).

Said rotating-flaps (1) comprising at least one set of rotating flaps, i.e., at least one maneuverable, preferably rotatable flap, being either at least partially flexible or rigid; and at least one rigid-support. Said maneuverable flap is having an open configuration (1RO, 1LO for example) and a closed configuration (1RC, 1LC for example). In its closed configuration, see for example left-hand flap (1LC), flap (1LC) is cuffing an elongated tubular bonny organ, e.g., patient's left leg (8L) in the manner that a rigid-support (2L) and maneuverable flap (1LC) are embracing leg (8L). A rotating shaft (3), being either concentric or eccentric member, is connected in one side to a motor, such as an electric rotating motor, and to said rotating shaft (3) in the other side.

While shaft (3) rotates in direction (4A), it causes tension to straps 6, rotating-member 7 and straps 9, which forcefully presses maneuverable flap (1LC) along hinge 1H towards rigid-support (2L) in a direction 4B. The timing inflating the maneuverable flaps (i.e., 1LC, 1RC) during diastole, the period when the heart muscle relaxes and the chambers fill with blood. The cuffs are being pressed sequentially, resulting in increased pressure in the aorta and coronary arteries. Compression of the vascular bed in the legs further increases the return of venous blood to the heart and increases cardiac output.

It is well in the scope of the present invention wherein said pressing of the rotating flaps is provided simultaneously, i.e., right and left organs (e.g., legs) are treated by the 1RC and 1LC flaps, respectively. It is further in the scope of the present invention wherein an array of rotating flaps is actuated in a coordinated manner. Such an array is selected from rotating flaps located in different locations, e.g., calves, thighs and buttocks of the treated patient, and/or a plurality of flaps arranged as an operating stack. One possible operating stack is a module comprising two or more adjacent flaps, at least one rotating flap is located in a respectively low position, and at least one rotating flap is located in a higher position, such that the lower flap or flaps are pressed before the higher flap or flaps, and a unidirectional blood flow is obtained.

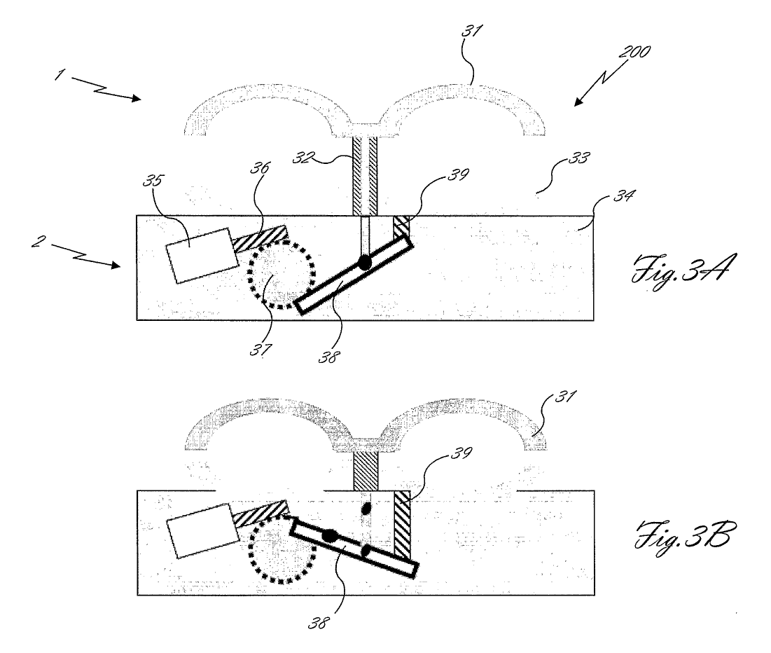

Reference is made now to FIG. 3, presenting another embodiment of the RS-EECP (200) device, namely a pressing-cuffs model, comprising inter alia two operational modules: a plurality of pressing-cuffs (1) and a cuffs pressing mechanism (2). FIG. 3 is schematically illustrating RS-EECP device (200) in its two extreme phases: when fully released, i.e., schemes A, upper view; and when fully compressed, i.e., scheme B, lower and partial view presenting only one mechanism (2). The maneuverable cuffs (31) are connected to a shaft having a linear (e.g., approximately perpendicular) motion (32). At a given time, said pressing cuffs are fastened towards a solid support (33). Said motion can be provided by various means, such as rotating engine (35) in connection with a suitable gear (36, 37) such that a rotating clog wheel is maneuvering shaft 38, being eccentrically connected to the same. Said shaft (38) is connected in its other end to said vertically actuated shaft 32; and to at least one returning spring (39).

It is well in the scope of the present invention wherein said pressing of the pressing cuffs is provided simultaneously, i.e., right and left organs (e.g., legs). It is further in the scope of the present invention wherein an array pressing cuffs is actuated in a coordinated manner. Such an array is selected from pressing cuffs located in different locations, e.g., calves, thighs and buttocks of the treated patient, and/or a plurality of flaps arranged as an operating stack. One possible operating stack is a module comprising two or more adjacent pressing cuffs, at least one pressing cuff is located in a respectively low position, and at least one pressing cuff is located in a higher position, such that the lower cuff or cuffs are pressed before the higher cuff or cuffs, and a unidirectional blood flow is obtained.

EECP mechanisms known in the art are adapted to inflate and deflate a series of compressive elastic cuffs that are wrapped around the calves and lower and upper thighs. The basic principle involved is that of counterpulsation. The stretchy cuffs inflate during diastole, the period when the heart muscle relaxes and the chambers fill with blood. The cuffs inflate sequentially from the calves upwards, resulting in increased pressure in the aorta and coronary arteries. Compression of the vascular bed in the legs also increases the return of venous blood to the heart and increases cardiac output.

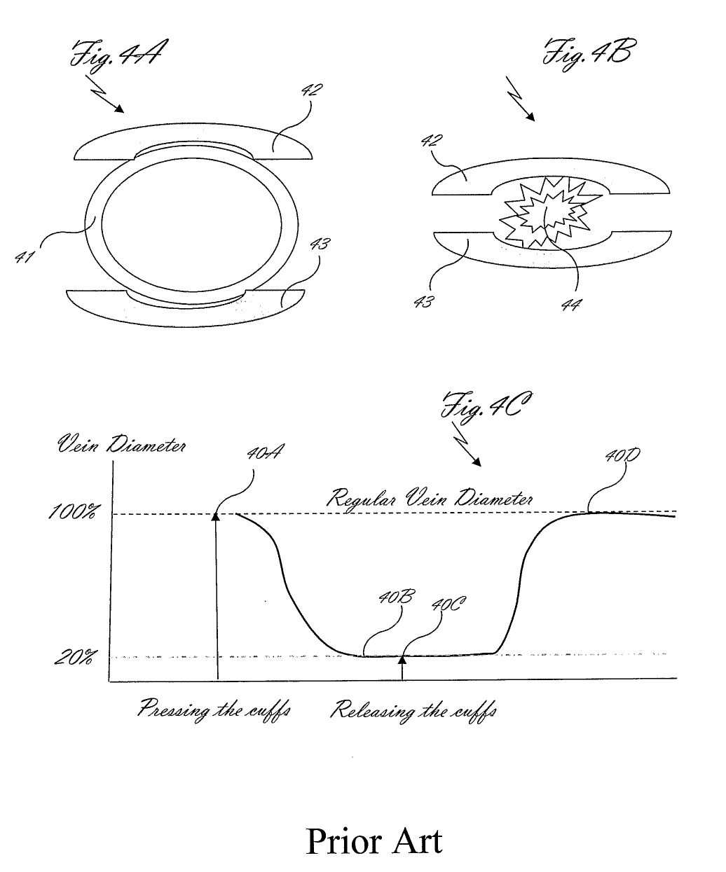

Reference is made now to FIG. 4, illustrating in scheme a cross section of a vein or artery (41) being enveloped by two elastic cuffs (42, 43) being in its deflated configuration. Scheme B illustrating the same in its inflated state, wherein the vein or artery is pressed (44) and narrowed. Scheme C presents an approximated inflation/deflation curve. At the starting point, the vein or artery internal diameter is set to be 100%. By pressing the elastic cuffs described above (40A), the internal diameter of the vein or artery is decrease (40B). The timing of setting the pressure is defined by the systole/diastole cycle. After on-setting cuffs' deflation (40C), a lag period is usually obtained, and then the internal diameter of the vein or artery or artery is increase to the initial starting point (40D).

The core of the invention further lies in the novel pressing mechanism wherein the vein or artery is pressed against a non-flexible support, such that the internal diameter of the pressed vein or artery is equal or smaller than the art, and the lag period is shorten. By that, an accurate timing of the cuffs' inflation/deflation pulsation is provided.

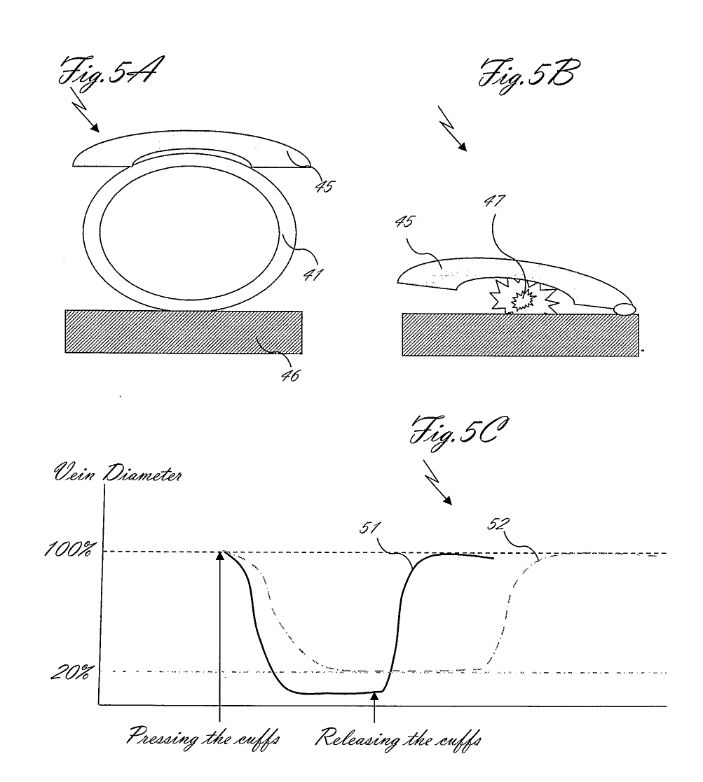

Reference is made hence to FIG. 5, particularly to scheme A, illustrating a cross section view of a vein or artery (41) fastened in between a flexible cuff (45) and a non-flexible support (46). Scheme B presenting the same, wherein flexible cuff (45) is forcefully pressed towards the solid support, such as the internal diameter of the vein or artery is significantly (47) reduced. Scheme B is similar in its principle to the RS-EECP device described in FIG. 2. Scheme C shows two inflation/deflation curves, wherein curve 51 presents an effective vein or artery narrowing and a prompt response provided in the RS-EECP device of the present invention, as compared with the art (curve 52, see FIG. 4).

The present further discloses an EECP as defined in any of the above, being in communication with at least one imaging device, especially CT, MRI, Ultrasound Nuclear scanning means (isotopes), useful for enhancement blood flow and perfusion during imaging test. The EECP as defined above is preferably, yet not exclusively being in communication with imaging device especially CT, MRI, Ultrasound, Nuclear scamming means (isotopes), useful for enhancement blood flow and perfusion during imaging test; wherein said EECP and/or imaging device are in communication with a plurality of injectors and possibly with patient's diagnostic devices. The method according to claim 16, further comprising stabilizing the patient during treatment and external fixing of patient's legs, thighs and upper torso by immobilizing means.

Moreover, the present invention also depicts a non-invasive method as defined above, useful for out-patient treatment of arterial insufficiency states, by providing precise onset of a blood flow characterized by a sharp-wave front, comprising providing a portable CPR device. The said portable CPR means is used independently, in conjunction and/or in communication with a defibrillator such that a synergic resuscitating system is obtained. The synergic resuscitating system as defined above is controlled by at least one controlling means.

1. A non-invasive rigid-support enhanced external counterpulsation device (RS-EECP) providing a precise onset of a blood flow characterized by a sharp-wave front, useful for out-patient treatment of arterial insufficiency states, especially angina; said RS-EECP comprising a timing means and a plurality of pressing cuffs; said timing means is adapted to onset the collapsing and expanding maneuvers of the cuffs in a sequence of occasions defined along the diastolic/systolic cycle; said cuffs are fastened around at least a portion of the circumference of at least one organ comprising a vascular bed to counterpulsate against an either fixed or maneuverable support; wherein said support is a rigid member; so as a quick expansion of said vessel bed, following a forceful and effective collapsing of the same is obtained.

2. The RS-EECP according to claim 1, comprising two or more pressing cuffs, being arranged adjacently along the patient's organ in a series such that one cuff or cuffs are located at a retrograde position in respect to others.

3. The RS-EECP according to claim 2, wherein the cuff or cuffs being located at the retrograde position are scheduled to collapse prior to others, such as a unidirectional blood flow is provided.

4. An array of RS-EECPs each of which is defined in claim 1, comprising two or more RS-EECPs, being arranged along the patient's body in series and/or in parallel, such that at least one RS-EECP is located at a retrograde position in respect to others.

5. The array of RS-EECP according to claim 4, wherein one or more RS-EECPs being located at the retrograde position are scheduled to collapse prior to others, such as a peristaltic unidirectional blood flow along the treated patient's body portion is provided.

6. The RS-EECP according to claim 1, being in communication with at least one imaging means (i.e., IRS-EECP); said imaging means are adapted to display said blood flow, tissue perfusion, perfusion pressure or the flow of markers or medicaments solubilized therein.

7. The IRS-EECP according to claim 6, wherein the imaging means is selected from cardiac CT, CT-angio, cardiac and vascular MRI, ultrasound Doppler for the carotids and renal vessels, isotope based scans, PET Scans or any combination thereof. The IRS-EECP according to claim 6, wherein the markers, contrasting agents and/or image contrasting means are selected from commercially available substances, known compositions or agents used for enhancing or depicting vascular flow or as a measure of tissue perfusion, in conjunction with the above mentioned imaging modalities.

8. The IRS-EECP according to claim 6, wherein the medicaments are selected from dopamine and nitroglycerine.

9. The RS-EECP (100) according to claim 1 comprising a plurality of rotating-cuffs (1) and a mechanism for rotating the same (2); said rotating-cuffs (1) comprising at least one set of rotating cuffs being either at least partially flexible or rigid; and at least one rigid-support; said maneuverable cuff is having an open configuration (collapsed state) and a closed configuration (released state); wherein at said collapsed state, said cuffs are fastened around at least a portion of the circumference of at least one organ comprising a vascular bed to counterpulsate against an either fixed or maneuverable support.

10. The RS-EECP (100) according to claim 9, further comprising a rotating shaft (3), being either concentric or eccentric member; shaft (3) is connected to a motor, rotating the same; and hence, either directly or indirectly, it forcefully compresses the maneuverable cuffs.

11. The RS-EECP (200) according to claim 1 comprising inter alia a plurality of pressing-cuffs (1) and a mechanism for pressing the same (2).

12. The RS-EECP (200) according to claim 9, further comprising maneuverable cuffs (31) being connected to a shaft having a linear (e.g., approximately perpendicular) motion (32), such as at a given time, said pressing cuffs are fastened towards a rigid support (33).

13. The RS-EECP (200) according to claim 1, further comprising at least one external fixation means adapted to immobilize the patient or organs thereof during activation of the RS-EECP.

14. An EECP, being in communication with at least one imaging device, especially CT, MRI, Ultrasound Nuclear scanning means (isotopes), useful for enhancement blood flow and perfusion during imaging test.

15. The EECP according to claim 14, being in communication with imaging device especially CT, MRI, Ultrasound, Nuclear scanning means (isotopes), useful for enhancement blood flow and perfusion during imaging test; wherein said EECP and/or imaging device are in communication with a plurality of injectors and possibly with patient's diagnostic devices.

16. The EECP according to claim 1, further comprising a synergic resuscitating system comprising CPR and a defibrillator; said portable CPR is utilizable in independent manner, in conjunction and/or in communication with said defibrillator.

17. The method according to claim 16, further comprising at least one controlling means adapted to monitor said synergic resuscitating system.

18. A non-invasive method for out-patient treating of arterial insufficiency states, especially angina by providing a precise onset of a blood flow characterized by a sharp-wave front.

19. The method according to claim 18, comprising:
a. obtaining a timing means and a plurality of pressing cuffs;
b. fastening cuffs around at least a portion of the circumference of at least one organ comprising a vascular bed to counterpulsate against an either fixed or maneuverable support; wherein said support is a rigid member;
c. initiating the collapsing and expanding maneuvers of the cuffs in a sequence of occasions defined along the diastolic/systolic cycle;
such as a quick expansion of said vessel bed, following a forceful and effective collapsing of the same is obtained.

20. The method according to claim 18, comprising obtaining two or more pressing cuffs, setting the same adjacently along the patient's organ in a series such that one cuff or cuffs are located at a retrograde position in respect to others.

21. The method according to claim 18, comprising locating cuff or cuffs at a retrograde position and then collapsing the same prior to others, such as a unidirectional blood flow is provided.

22. The method according to claim 18, comprising obtaining two or more RS-EECPs, and arranging the same along the patient's body in series and/or in parallel, such that at least one RS-EECP is located at a retrograde position in respect to others.

23. The method according to claim 18, comprising locating one or more RS-EECPs at the retrograde position and initiating the same to collapse prior to others, such as a peristaltic unidirectional blood flow along the treated patient's body portion is provided.

24. The method according to claim 18, comprising communicating the RS-EECP system with at least one imaging means (i.e., IRS-EECP); said imaging means are adapted for displaying said blood flow or the flow of markers or medicaments solubilized therein.

25. The method according to claim 24, wherein the imaging is selected from providing cardiac CT, CT-angio, cardiac and vascular MRI, ultrasound Doppler for the carotids and renal vessels, isotope based scans, preferably PET scans or any combination thereof.

26. The method according to claim 24, comprising utilizing commercially available markers, known contrasting agents and/or image contrasting means.

27. The method according to claim 22, comprising medicaments selected from dopamine or nitroglycerine.

28. The method according to claim 18, further comprising stabilizing the patient during treatment and external fixing of patient's legs, thighs and upper torso by immobilizing means.

29. The non-invasive method according to claim 18, useful for out-patient treating of arterial insufficiency states, comprising at least one step of providing a precise onset of a blood flow characterized by a sharp-wave front, comprising providing a portable CPR device.

30. The method according to claim 28, further comprising obtaining a synergic resuscitating system comprising CPR and a defibrillator; utilizing said portable CPR in an independent manner, in a conjunction and/or in a communication with said defibrillator.

31. The method according to claim 29, comprising monitoring said synergic resuscitating system with at least one controlling means.
